(19) United States
(12) Patent Application Publication
(10) Pub. No.: US 2024/0297903 A1
(43) Pub. Date: Sep. 5, 2024

(54) ACCESS CONTROL SYSTEM, ACCESS CONTROL METHOD, AND ACCESS CONTROL PROGRAM

(71) Applicant: NEC Corporation, Tokyo (JP)

(72) Inventors: Nakul GHATE, Tokyo (JP); Shohei MITANI, Tokyo (JP); Hirofumi UEDA, Tokyo (JP)

(73) Assignee: NEC Corporation, Tokyo (JP)

(21) Appl. No.: 18/582,972

(22) Filed: Feb. 21, 2024

(30) Foreign Application Priority Data
Mar. 3, 2023 (JP) 2023-033054

(51) Int. Cl. H04L 9/40

(52) U.S. Cl. CPC H04L 63/20; H04L 63/101; H04L 63/1433

(57) ABSTRACT

An access control system includes workload distribution control function that decides an access control granularity by analyzing dynamic risk factors in network system; and policy selection function that selects an access control policy corresponding to the access control granularity, from a core policy and distributes the selected access control policy toward filtering PEP (Policy Enforcement Point) controller and fine-grained PEP (Policy Enforcement Point) controller.

### FIELD

### Cross Reference to Related Applications

This application is based upon and claims the benefit of the priority of Japanese patent application No. 2023-033054, filed on Mar. 3, 2023, the disclosure of which is incorporated herein in its entirety by reference thereto.

The present invention relates to an access control system, access control method, and access control program, for achieving optimum performance of a network system.

### BACKGROUND

Access control is a typical security tool to prevent network attacks. In access control, the first step is to create policy rules that define who is allowed to perform what operations on it. Then, according to those rules, user actions are allowed or denied.

A firewall is one type of access control, which permits/denies processing on a packet-by-packet based on pre-defined policy rules. PLT 1 discloses a firewall system in which the access control granularity is selected only according to application security requirements.
[PLT 1] US Patent Application Publication Number US2007/0234414A1

### SUMMARY

The disclosures of the above prior art document shall be incorporated by reference into this document. The following analysis has been made by the inventors.

Fine-grained (access control on both application layer and network layer) improves security but greatly increases access control workload. Coarse-grained (access control only on network layer) helps in reducing the workload but may provide inadequate security. Depending on the access control granularity (coarse-grained or fine-grained), there is a trade-off between security and workload.

Moreover, the best choice of the access control granularity to reduce the workload while satisfying the security requirement, varies according to the change in environment (dynamicity). It is required to dynamically determine the granularity of access control so that the workload can be reduced while satisfying security requirements, and to apply policy rules suitable for the determined granularity.

In view of the above problems, it is an object of the present invention to provide an access control system, access control method, and access control program that contribute to reduce the workload while satisfying security requirements.

According to a first aspect of the present invention, there is provided an access control system, comprising: workload distribution control function that decides an access control granularity by analyzing dynamic risk factors in network system; and policy selection function that selects an access control policy corresponding to the access control granularity, from a core policy and distributes the selected access control policy toward filtering PEP (Policy Enforcement Point) controller and fine-grained PEP (Policy Enforcement Point) controller.

According to a second aspect of the present invention, there is provided an access control method, comprising: deciding an access control granularity by analyzing dynamic risk factors in network system; selecting an access control policy corresponding to the access control granularity, from a core policy; and distributing the selected access control policy to filtering PEP (Policy Enforcement Point) controller and fine-grained PEP (Policy Enforcement Point) controller.

According to a third aspect of the present invention, there is provided an access control program instructing a computer: deciding an access control granularity by analyzing dynamic risk factors in network system; selecting an access control policy corresponding to the access control granularity, from a core policy; and distributing the selected access control policy to filtering PEP (Policy Enforcement Point) controller and fine-grained PEP (Policy Enforcement Point) controller. Further, this program can be stored in a computer-readable storage medium. The storage medium may be non-transitory one such as a semiconductor memory, a hard disk, a magnetic recording medium, an optical recording medium, and the like. The present invention can also be realized as a computer program product.

According to each aspect of the present invention, there can be provided an access control system, access control method, and access control program that contribute to reduce the workload while satisfying security requirements.

### BRIEF DESCRIPTION OF DRAWINGS

FIG. 1 is schematic diagram for explaining an access control system.

FIG. 2 is schematic diagram for explaining function of the access control system.

FIG. 3 is schematic diagram for illustrating an example to be applied in the access control system.

FIG. 4 is schematic diagram for illustrating a low risk example to be applied in the access control system.

FIG. 5 is schematic diagram for illustrating a moderate risk example to be applied in the access control system.

FIG. 6 is schematic diagram for illustrating a high risk example to be applied in the access control system.

FIG. 7 is schematic diagram for illustrating a high risk example to be applied in the access control system.

FIG. 8 is schematic diagram for summary of access control granularity cases.

FIG. 9 is a flow chart that shows a schematic access control method.

FIG. 10 is a drawing illustrating an example of a hardware configuration of an access control distribution unit.

### EXAMPLE EMBODIMENTS

Example embodiments of the present invention will be described with reference to the drawings. However, the present invention is not limited to the example embodiments described below. Further, in each drawing, the same or corresponding elements are appropriately designated by the same reference signs. It should be noted that the drawings are schematic, and the dimensional relationships and the ratios between the elements may differ from the actual ones. There may also be parts where the dimensional relationships and the ratios between drawings are different.

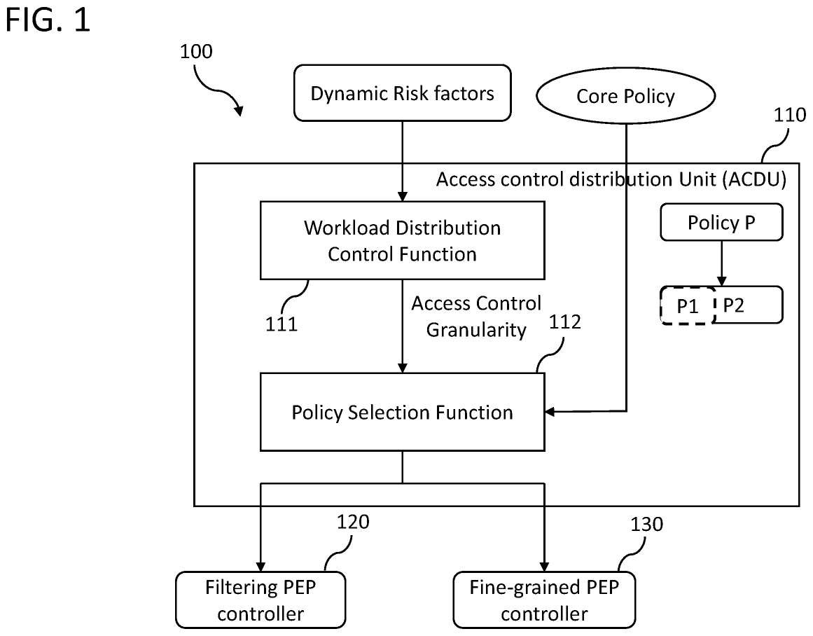

FIG. 1 is schematic diagram for explaining an access control system. As shown in FIG. 1, the access control system 100 comprises access control distribution unit 110, filtering PEP controller 120 and fine-grained PEP controller 130.

Access control distribution unit 110 has its input, dynamic risk factors and analyses the dynamic risk factors select to select the appropriate access control policy, and then distribute the access control policy toward filtering PEP (Policy Enforcement Point) controller 120 and fine-grained PEP (Policy Enforcement Point) controller 130.

Access control distribution unit 110 comprises workload distribution control function 111 and policy selection function 112. Workload distribution control function 111 decides the access control granularity by analyzing dynamic risk factors in network system. Policy selection function 112 selects an access control policy corresponding to the access control granularity, from the core policy and distributes the selected access control policy toward filtering PEP controller 120 and fine-grained PEP controller 130.

The core policy P comprises one fine-grained access control policy P2 and one or more access control policies P1 converted from the fine-grained access control policy to a coarser form. The coarser access control policy P1 is selected such that its permission decisions are consistent with those of fine-grained access control policy P2 at a current state of a device, resource, and network. The coarser access control policy P1 is coarser compared to the fine-grained access control policy P2 in terms of:
1. Number of rules in the coarse-grained policies are fewer compared to fine-grained policy.
2. The number of attributes used in the coarse-grained policy are fewer compared to fine-grained policy, where in the attributes refer to the concrete representation of “state” which may represent trust level, risk profile, confidentiality of the resource and so on.
3. In one aspect, the coarse-grained policy can be a group-policy compared to a fine-grained policy which is in its sense particular to each user, each device, each resource and other attributes mentioned in 2.

### Example

A coarse-grained policy is defined with network identifiers or attributes. Src IP 192.168.1.1 is allowed to access Dst IP 10.1.1.1 when the current status of the IDS system shows “Src IP 192.168.1.1 is low risk”. If the Src IP 192.168.1.1 contains 10 devices and the Dst IP 10.1.1.1 contains 15 resources, then we can generate 10*15 number of individual rules, and adding device risk and trust level, resource confidentiality etc., a fine-grained policy can be defined for all of them. Thus, even for one src IP and one Dst IP, a fine-grained policy can contain much larger number of rules (150 in this case) and can be defined with much larger space of attributes/identifiers.

The fine-grained access control policy P2 is an access control list at an application layer and the coarse-form access control policy P1 is a network layer access control list substituted for a portion thereof.

### Example

1. Application layer policies such that those which may differentiate access control based on the type of application layer protocol such as but not limited to, http, ftp, smtp, dns, telnet, and others.
2. Application layer policies such that those which may even differentiate two applications using the same application layer protocol, such as but not limited to, two different browsers, two different email clients, and others among them.
3. Application layer policies which differentiate two users using the same application over the same application protocol based on but not limited to, user passwords, authentication, behavior, contextual state and others among them.
4. Application layer policies which differentiate the same user using the same application over the same application protocol but accessing two different digital assets based on such as but not limited to, the confidentiality of the asset, access needs, passwords, authentication, behavior, contextual state and others among them.
5. Application layer policies which differentiate the same user accessing the same digital asset using the same application over the same application protocol but accessing different devices based on such as but not limited to, device risk profile, device trust level, hardware and software, communication protocols, and such among others.
6. Application layer policies which differentiate the same user accessing the same digital asset using the same application over the same application on the same device but accessing with different context such as but not limited to, change in user behavior, change in location and time, change in device behavior, change in device security state, authentication and security threat and such among others.
7. Any other policy which is not an application layer policy but differentiates with such fine grain but not limited to the examples written in 1-4.

The workload distribution control function 111 calculates a risk score of the device that varies according to the state and the policy selection function selects 112 the coarse policy when the risk score is high or low and selects the fine-grained policy when the risk is moderate.

Access control distribution unit 110 comprises at least two PEPs in series, a PEP implementing the coarse policy and another PEP implementing a detailed policy, as means of executing the selected access control policy. The filtering PEP controller 120 control the one PEP by coarse-form access controls policy P1. The fine-grained PEP controller 130 controls the other PEP by the fine-grained access control policy P2.

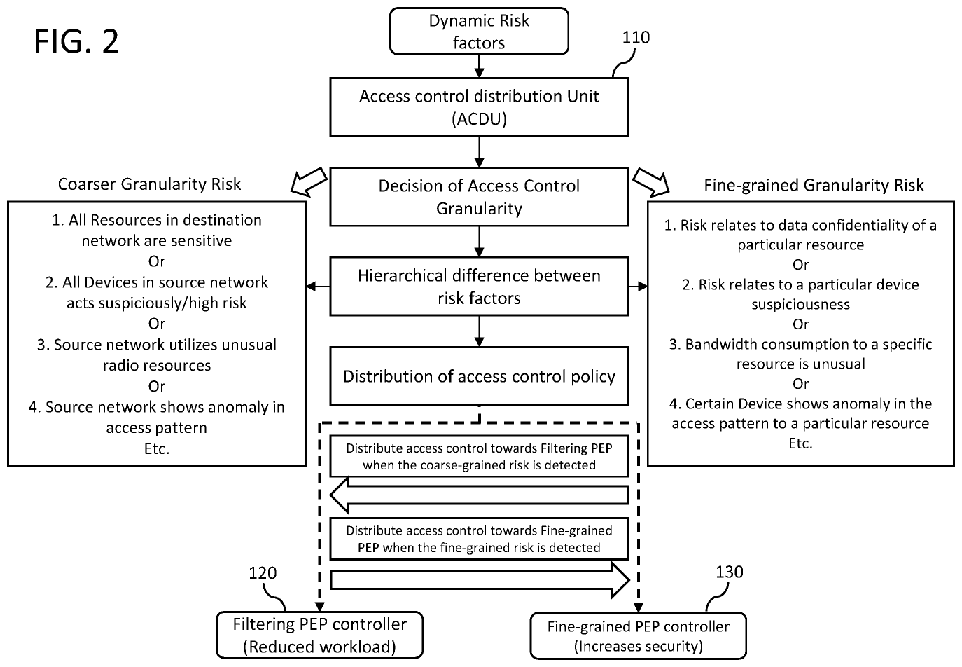

FIG. 2 is schematic diagram for explaining function of the access control system. As shown in FIG. 2, access control distribution unit 110 is input dynamic risk factors and decide access control granularity.

Risk factors in network system contain hierarchical difference and change dynamically. Access control distribution unit 110 analyses the dynamic risk factors and decide access control granularity by analyzing the dynamic risk factors.

Examples of risk factors include:
1. Threat from malicious device; whose maliciousness may be detected from but not limited to, its weak security posture, lack of trusted software installed, installing of unknown or suspicious software, failing of authentication, unusual activities such as requesting unauthorized resource, unusual access pattern, login time, location and any of the other factors through which a suspicion can be formed for maliciousness of device.
2. Threat from malicious user; whose maliciousness may be detected from but not limited to, failing authentication, requesting unauthorized resource, using non-managed device for requesting resource which requires using a managed device, suspicious behavior such as unusual access pattern, login time, location and any of the other factors through which a suspicion can be formed for maliciousness of user.
3. Threat from malicious actors in the network environment; whose maliciousness may be detected from but not limited to, modification of network packet in-transit, requesting unusual amounts of packet for an access, packets arriving from a network path different from the agreed path, modification of cryptographic variables, poisoning of TCP or IP headers, and any of the other factors through which a suspicion can be formed for maliciousness of network environment.
4. Threat on a sensitive resource; whose sensitivity may be detected from but not limited to, confidentiality of the resource, having been requested by unauthorized user or device, having been requested by malicious user or device, having been attacked on by malicious actors in the network or any other factors through which a suspicion can be formed for threat on a sensitive resource.

The risk in the dynamic environment can be detected by variety of detection mechanism such as Intrusion Detection system, Intrusion prevention system, System Information and Event Management, Trusted Platform Module, and so on.

Risk factors in network system can be divided into two categories: Coarser Granularity Risk and Fine-grained Granularity Risk. For example, Coarser Granularity Risk contains 1. All Resources in destination network are sensitive, Or 2. All Devices in source network acts suspiciously/high risk, Or 3. Source network utilizes unusual radio resources, Or 4. Source network shows anomaly in access pattern Etc. For example, Fine-grained Granularity Risk contains 1. Risk relates to data confidentiality of a particular resource, Or 2. Risk relates to a particular device suspiciousness, Or 3. Bandwidth consumption to a specific resource is unusual, Or 4. Certain Device shows anomaly in the access pattern to a particular resource Etc.

Access control distribution unit 110 distributes access control towards Filtering PEP when the coarse-grained risk is detected and distributes access control towards fine-grained PEP when the fine-grained risk is detected.

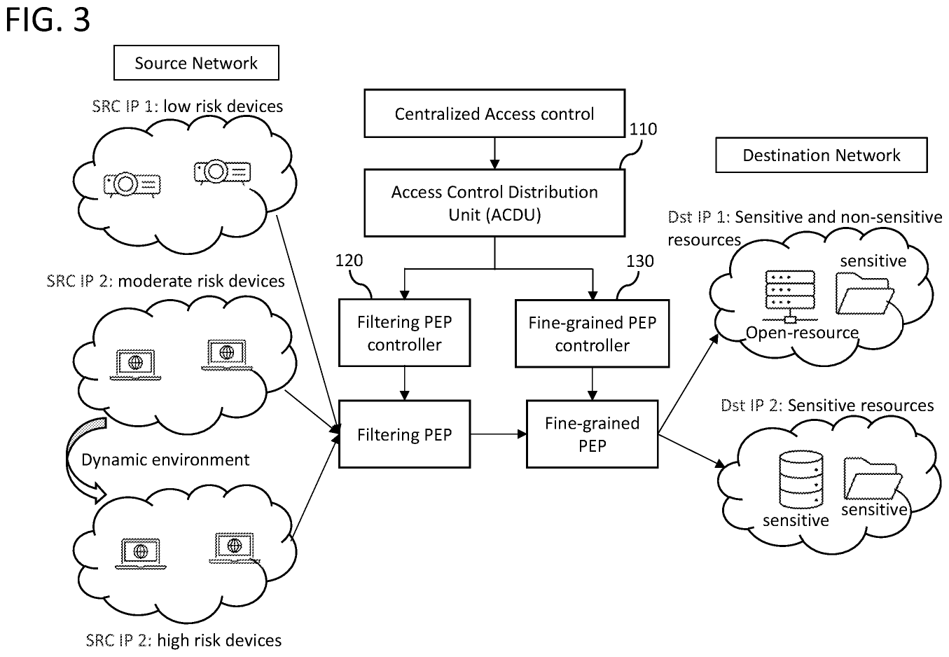

FIG. 3 is schematic diagram for illustrating an example to be applied in the access control system. As shown in FIG. 3, access control system 100 controls access from Source Network to Destination Network. Source Network contains SRC IP 1: low risk devices and SRC IP 2: moderate/high risk devices. Destination Network contains Dst IP 1: Sensitive and non-sensitive resources and Dst IP 2: Sensitive resources. The moderate risk devices can be varied into high risk devices in dynamic environment. The access control system 100 needs to treat dynamic risk factors in this situation.

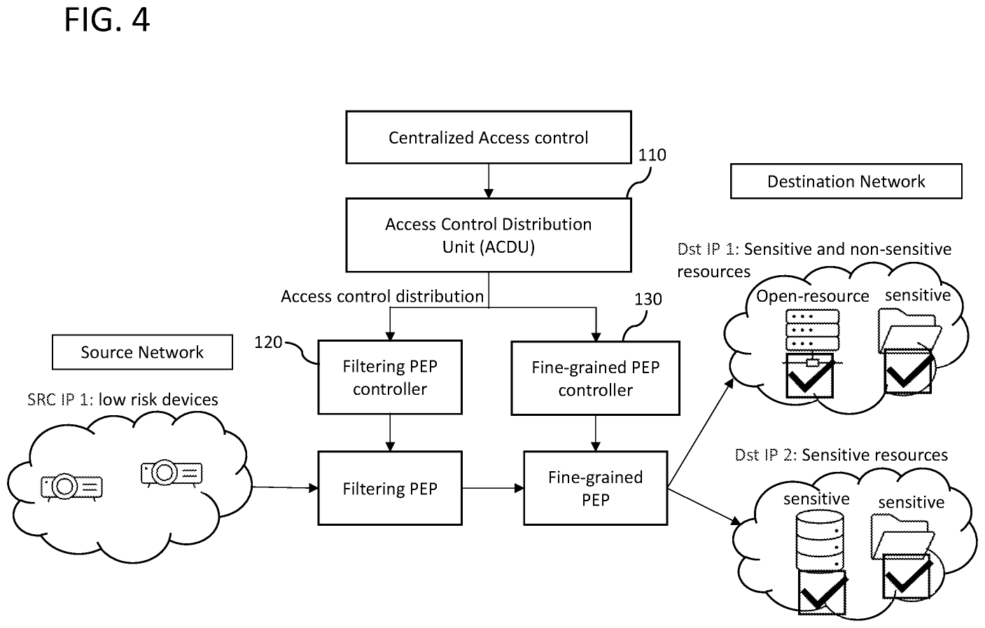

FIG. 4 is schematic diagram for illustrating a low risk example to be applied in the access control system. In this situation, SRC IP 1: low risk devices would like to access to Dst IP 1: Sensitive and non-sensitive resources and Dst IP 2: Sensitive resources. The access control system 100 does not block the access because SRC IP 1: low risk devices are not in risk. Access control distribution unit (ACDU) 110 distributes access control policy toward to filtering PEP controller 120 to allow SRC IP 1: low risk devices access to Dst IP 1: Sensitive and non-sensitive resources and Dst IP 2: Sensitive resources.

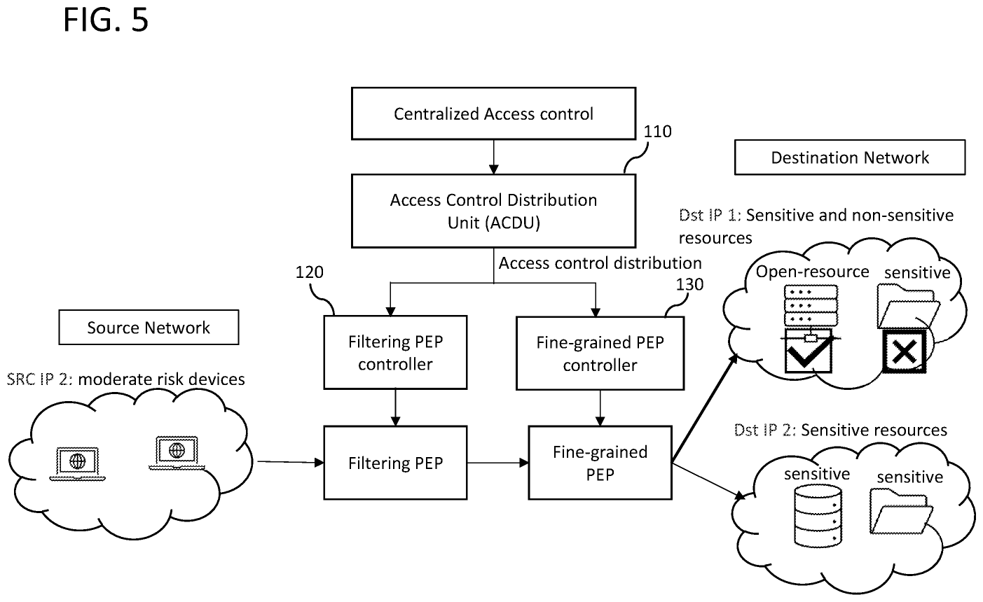

FIG. 5 is schematic diagram for illustrating a moderate risk example to be applied in the access control system. In this situation, SRC IP 2: moderate risk devices would like to access to Dst IP 1: Sensitive and non-sensitive resources, which contains Sensitive and non-sensitive resources. The access control system 100 need to control access in fine-grained granularity. SRC IP 2: moderate risk devices should be allowed to access to Open-resource but not allowed to access to sensitive resource. Access control distribution unit (ACDU) 110 distributes fined-grained access control policy toward fine-grained PEP controller 130 to allow SRC IP 2: moderate risk devices access to Open-resource and block SRC IP 2: moderate risk devices access to sensitive resource.

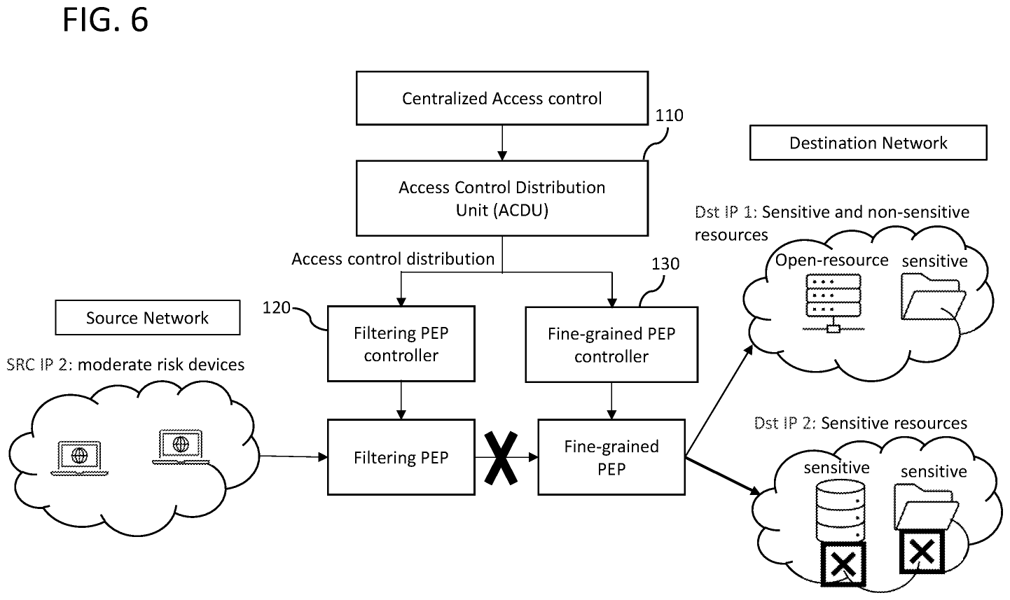

FIG. 6 is schematic diagram for illustrating a high risk example to be applied in the access control system. In this situation, SRC IP 2: moderate risk devices would like to access to Dst IP 2: Sensitive resources. The access control system 100 does not need to control access in fine-grained granularity because SRC IP 2: moderate risk devices should not be allowed to access to Dst IP 2: Sensitive resources. Access control distribution unit (ACDU) 110 distributes coarse-grained access control policy toward filtering PEP controller 120 to block access from SRC IP 2: moderate risk devices to Dst IP 2: Sensitive resources.

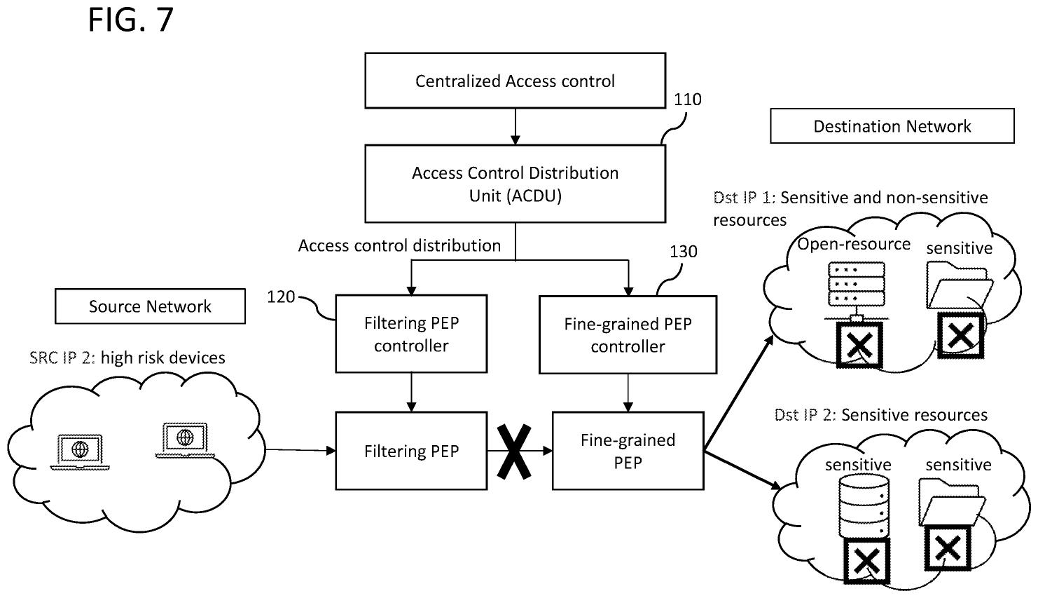

FIG. 7 is schematic diagram for illustrating a high risk example to be applied in the access control system. In this situation, SRC IP 2: high risk devices would like to access to Dst IP 1: Sensitive and non-sensitive resources and Dst IP 2: Sensitive resources. The access control system 100 does not need to control access in fine-grained granularity because SRC IP 2: high risk devices should not be allowed to access to Dst IP 1: Sensitive and non-sensitive resources and Dst IP 2: Sensitive resources. Access control distribution unit (ACDU) 110 distributes coarse-grained access control policy toward filtering PEP controller 120 to block access from SRC IP 2: high risk devices to Dst IP 1: Sensitive and non-sensitive resources and Dst IP 2: Sensitive resources.

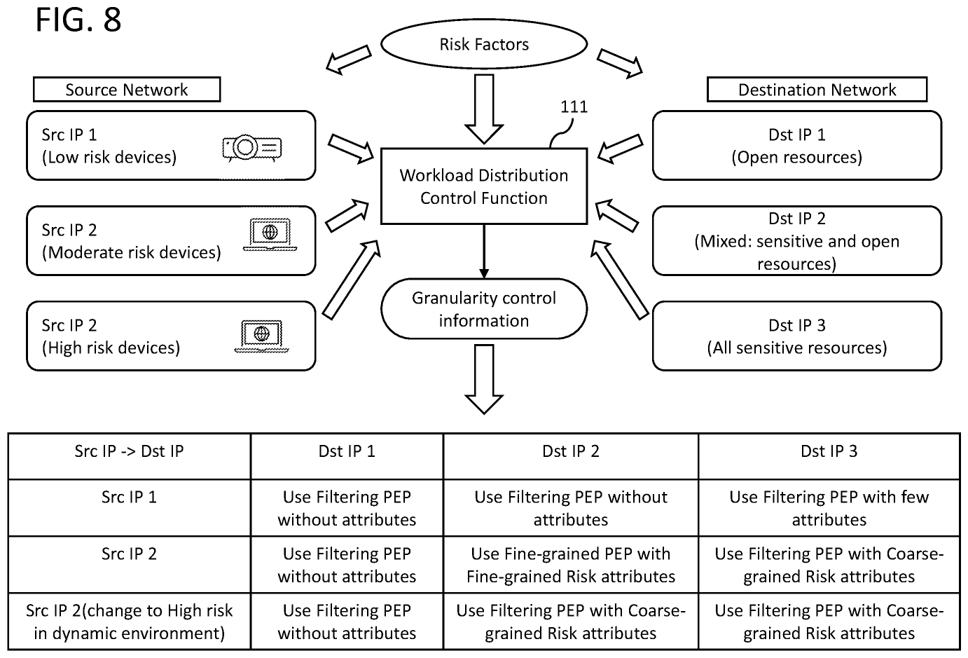

FIG. 8 is schematic diagram for summary of access control granularity cases. As shown in FIG. 8, workload distribution control function 111 analyses risk factors and decides granularity for access control. Source Network contains SRC IP 1: low risk devices and SRC IP 2: moderate/high risk devices. Destination Network contains Dst IP 1: Open resources, Dst IP 2: Mixed Sensitive and non-sensitive resources and Dst IP 3: All Sensitive resources. The moderate risk devices can be varied high risk devices in dynamic environment.

The workload distribution control function 111 calculates a risk score of the device that varies according to the state and the coarse policy is selected when the risk score is high or low and the fine-grained policy is selected when the risk is moderate. The Filtering PEP implements the coarse policy and the fine-grained PEP implements the detailed policy, as means of executing the selected access control policy.

In case where SRC IP 2: moderate risk devices would like to access to Dst IP 2: Mixed Sensitive and non-sensitive resources, the workload distribution control function 111 decides the fine-grained granularity for access control. In the other case, the workload distribution control function 111 decides the coarser granularity for access control. That is, the workload distribution control function 111 decides the coarser granularity for access control to reduce the workload while satisfying security requirements in many cases.

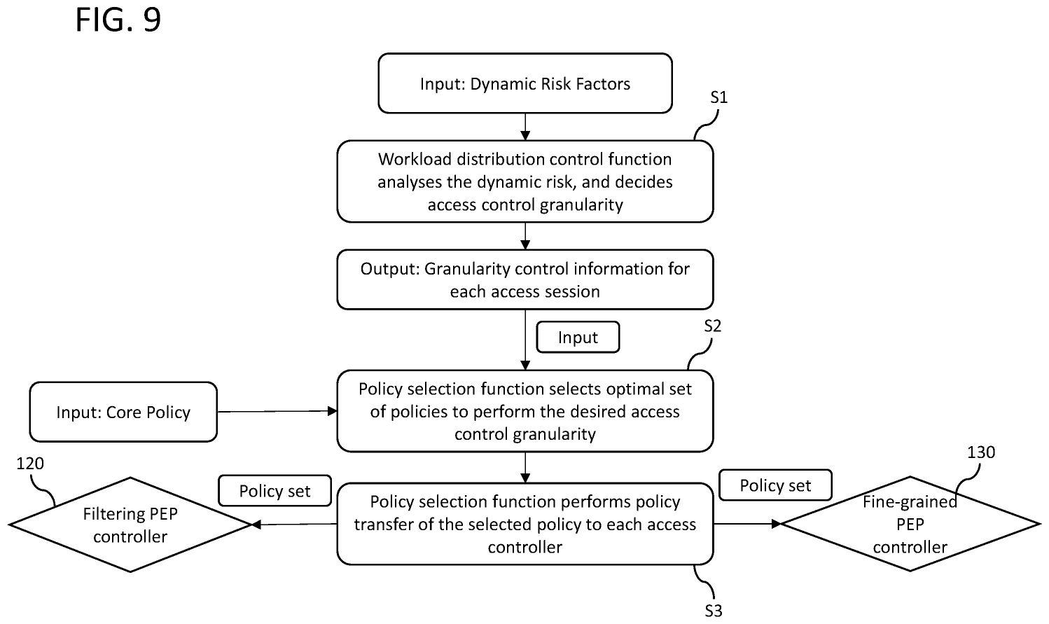

FIG. 9 is a flow chart that shows a schematic access control method. As shown in FIG. 9, the access control method includes deciding access control granularity step (S1), selecting policies step (S2) and transferring the selected policy step (S3).

In first step (S1), the workload distribution control function 111 analyses the Dynamic Risk Factors and decides access control granularity. The Dynamic Risk Factors in network system contain a device state, resource state, and/or network state. The workload distribution control function 111 calculates a risk score of the device that varies according to the state.

In second step (S2), the policy selection function 112 selects optimal set of policies from a Core Policy to perform a desired access control granularity, which is selected by the workload distribution control function 111. The policy selection function 112 (FIG. 1) selects the coarse policy when the risk score is high or low and selects the fine-grained policy when the risk is moderate.

In third step (S3), the policy selection function 112 performs policy transfer of the selected policy to each access controller. The policy selection function 112 transfer the coarse policy to filtering PEP controller 120 when the risk score is high or low and the fine-grained policy to fine-grained PEP controller 130 when the risk is moderate.

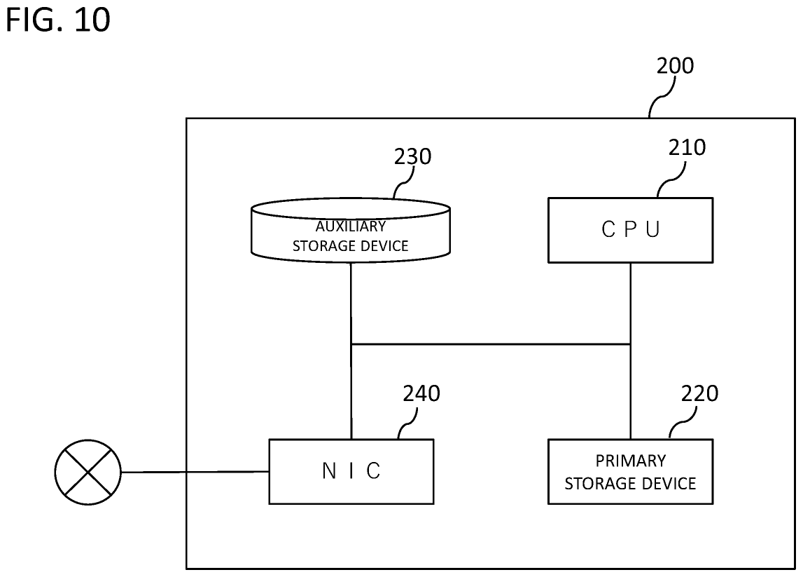

FIG. 10 is a drawing illustrating an example of the hardware configuration of the access control distribution unit. The access control distribution unit 110 described above may be configured as an information processing apparatus (computer) 200 having the hardware configuration shown in FIG. 10. It should be noted that the hardware configuration shown in FIG. 10 is merely an example of the hardware configuration realizing the function of the access control system 100 and is not intended to limit the hardware configuration of the access control distribution unit 110. The access control distribution unit 110 may include hardware not shown in FIG. 10.

As shown in FIG. 10, the computer 200 comprises a CPU (Central Processing Unit) 210, a primary storage device 220, an auxiliary storage device 230, and a NIC (Network Interface Card) 240, which is a communication interface. These elements are connected to each other by, for instance, an internal bus.

The CPU 210 executes the access control program. The primary storage device 220 is, for instance, a RAM (Random Access Memory) and temporarily stores the access control program executed by the computer 200 so that the CPU 210 can process it.

The auxiliary storage device 230 is, for instance, an HDD (Hard Disk Drive) and may store the access control program in the medium to long term. The access control program may be provided as a computer program stored in a non-transitory computer-readable storage medium. The auxiliary storage device 230 can be used to store the access control program stored in a non-transitory computer-readable storage medium over the medium to long term.

The NIC 240 provides an interface to an external terminal via a network. The NIC 240 is used to receive or to transmit traffic communications.

When the computer 200 as described above executes the access control program, the computer 200 acts as the access control distribution unit 110 and implements the access control method shown in FIG. 9.

The above example embodiments may partially or entirely be described, but not limited to, as the following notes.

### Note 1

An access control system, comprising:
workload distribution control function that decides an access control granularity by analyzing dynamic risk factors in network system; and
policy selection function that selects an access control policy corresponding to the access control granularity, from a core policy and distributes the selected access control policy toward filtering PEP (Policy Enforcement Point) controller and fine-grained PEP (Policy Enforcement Point) controller.

### Note 2

The access control system according to Note 1, wherein the core policy comprises one fine-grained access control policy and one or more coarser access control policies converted from a fine-grained access control policy to a coarser form, and wherein the coarser access control policy is selected such that its permission decisions are consistent with those of fine-grained access control policy at a current state of device, resource, and network.

### Note 3

The access control system according to Note 2, wherein the fine-grained access control policy is an access control list at an application layer and the coarse-form access control policy is a network layer access control list substituted for a portion thereof.

### Note 4

The access control system according to Note 3, wherein workload distribution control function calculates a risk score of the device that varies according to the state and the policy selection function selects the coarse policy when the risk score is high or low and selects the fine-grained policy when the risk is moderate.

### Note 5

The access control system according to Note 3, comprising at least two PEPs in series, a PEP implementing the coarse policy and another PEP implementing the detailed policy, for executing the selected access control policy.

### Note 6

An access control method, comprising:
deciding an access control granularity by analyzing dynamic risk factors in network system;
selecting an access control policy corresponding to the access control granularity, from a core policy; and
distributing the selected access control policy to filtering PEP (Policy Enforcement Point) controller and fine-grained PEP (Policy Enforcement Point) controller.

### Note 7

The access control method according to Note 6, wherein the core policy comprises one fine-grained access control policy and one or more coarser access control policies converted from the fine-grained access control policy to a coarser form, and wherein the coarser access control policy is selected such that its permission decisions are consistent with those of fine-grained access control policy at the current state of a device, resource, and network.

### Note 8

The access control method according to Note 7, wherein the fine-grained access control policy is an access control list at an application layer and the coarse-form access control policy is a network layer access control list substituted for a portion thereof.

### Note 9

The access control method according to Note 8, further comprising:
calculating a risk score of the device that varies according to the state,
selecting the coarse policy when the risk score is high or low, and
selecting the fine-grained policy when the risk is moderate.

### Note 10

An access control program instructing a computer:
deciding an access control granularity by analyzing dynamic risk factors in network system;
selecting an access control policy corresponding to the access control granularity, from a core policy; and
distributing the selected access control policy to filtering PEP (Policy Enforcement Point) controller and fine-grained PEP (Policy Enforcement Point) controller.

While each example embodiment of the present invention has been described, it is to be noted that it is possible to modify or adjust the example embodiments or examples within the whole disclosure of the present invention (including the Claims) and based on the basic technical concept thereof. Further, it is possible to variously combine or select (or at least partially remove) a wide variety of the disclosed elements (including the individual elements of the individual claims, the individual elements of the individual example embodiments or examples, and the individual elements of the individual figures) within the scope of the whole disclosure of the present invention. That is, it is self-explanatory that the present invention includes any types of variations and modifications to be done by a skilled person according to the whole disclosure including the Claims and the technical concept of the present invention. Particularly, any numerical ranges disclosed herein should be interpreted that any intermediate values or subranges falling within the disclosed ranges are also concretely disclosed even without specific recital thereof. Further, the disclosure of Patent Literature cited above is incorporated herein in its entirety by reference thereto.

What is claimed is:

1. An access control system, comprising:
workload distribution control function that decides an access control granularity by analyzing dynamic risk factors in network system; and
policy selection function that selects an access control policy corresponding to the access control granularity, from a core policy and distributes the selected access control policy toward filtering PEP (Policy Enforcement Point) controller and fine-grained PEP (Policy Enforcement Point) controller.

2. The access control system according to claim 1, wherein the core policy comprises one fine-grained access control policy and one or more coarser access control policies converted from the fine-grained access control policy to a coarser form, and wherein the coarser access control policy is selected such that its permission decisions are consistent with those of fine-grained access control policy at a current state of device, resource, and network.

3. The access control system according to claim 2, wherein the fine-grained access control policy is an access control list at an application layer and a coarse-form access control policy is a network layer access control list substituted for a portion thereof.

4. The access control system according to claim 3, wherein the workload distribution control function calculates a risk score of the device that varies according to the state, and the policy selection function selects the coarse policy when the risk score is high or low and selects the fine-grained policy when the risk is moderate.

5. The access control system according to claim 3, comprising at least two PEPs in series, a PEP implementing the coarse policy and another PEP implementing the detailed policy, for executing the selected access control policy.

6. An access control method, comprising:
deciding an access control granularity by analyzing dynamic risk factors in network system;
selecting an access control policy corresponding to the access control granularity, from a core policy; and
distributing the selected access control policy to filtering PEP (Policy Enforcement Point) controller and fine-grained PEP (Policy Enforcement Point) controller.

7. The access control method according to claim 6, wherein the core policy comprises one fine-grained access control policy and one or more coarser access control policies converted from the fine-grained access control policy to a coarser form, and wherein the coarser access control policy is selected such that its permission decisions are consistent with those of fine-grained access control policy at the current state of a device, resource, and network.

8. The access control method according to claim 7, wherein the fine-grained access control policy is an access control list at an application layer and the coarse-form access control policy is a network layer access control list substituted for a portion thereof.

9. The access control method according to claim 8, further comprising:
calculating a risk score of the device that varies according to the state,
selecting the coarse policy when the risk score is high or low, and
selecting the fine-grained policy when the risk is moderate.

10. A non-transitory computer readable medium storing an access control program instructing a computer:
deciding an access control granularity by analyzing dynamic risk factors in network system;
selecting an access control policy corresponding to the access control granularity, from a core policy; and
distributing the selected access control policy to filtering PEP (Policy Enforcement Point) controller and fine-grained PEP (Policy Enforcement Point) controller.

11. The non-transitory computer readable medium storing the access control program according to claim 10, wherein the core policy comprises one fine-grained access control policy and one or more coarser access control policies converted from the fine-grained access control policy to a coarser form, and wherein the coarser access control policy is selected such that its permission decisions are consistent with those of fine-grained access control policy at the current state of a device, resource, and network.

12. The non-transitory computer readable medium storing the access control program according to claim 11, wherein the fine-grained access control policy is an access control list at an application layer and the coarse-form access control policy is a network layer access control list substituted for a portion thereof.

13. The non-transitory computer readable medium storing the access control program according to claim 12, the access control program further instructing the computer:
calculating a risk score of the device that varies according to the state,
selecting the coarse policy when the risk score is high or low, and
selecting the fine-grained policy when the risk is moderate.
